(19) United States
(12) Patent Application Publication
(10) Pub. No.: US 2011/0015055 A1
(43) Pub. Date: Jan. 20, 2011

(54) METHOD FOR REMOVING A CATALYST INHIBITOR FROM A SUBSTRATE

(76) Inventor: Michael D. Cooper, Denver, NC (US)

Correspondence Address: DICKINSON WRIGHT PLLC, 1875 Eye Street, NW, Suite 1200, WASHINGTON, DC, 20006, US

(21) Appl. No.: 12/504,953

(22) Filed: Jul. 17, 2009

(51) Int. Cl. B01J 38/00

(52) U.S. Cl. 502/20

(57) ABSTRACT

This invention is directed to a process for removing a catalyst inhibitor from a substrate or catalytic converter containing at least one nitrogen oxide (NOₓ) catalyst using a phosphoric acid composition. The process is particularly suited for removing the catalyst inhibitor, arsenic, from a fly ash-coated substrate or converter. A substantial amount of catalyst inhibitor can be removed from a fly ash-coated catalytic converter without removing a significant portion of one or more of the NOₓ reduction catalysts in or on the substrate.

### FIELD OF THE INVENTION

This invention relates to a method for removing a catalyst inhibitor from a substrate having at least one nitrogen oxide reduction catalyst. In particular, the invention relates to a method for removing a catalyst inhibitor from a substrate or catalytic converter by contacting the substrate or catalytic converter with a phosphoric acid composition to remove at least a portion of the catalyst inhibitor from the catalytic converter.

### BACKGROUND OF THE INVENTION

A significant portion of electrical power produced throughout the world is produced in power plants that burn a fossil fuel (e.g., coal, oil, or gas). The burning of the fossil fuel provides heat that can be used to produce steam. This steam can then be used to drive a turbine and generator to produce electricity. Upon burning the fuel, a flue gas is also formed. In some cases, the flue gas itself is directly used to drive a turbine and generator to produce electricity. However, in either case, flue gas is formed as the fossil fuel is burned. The flue gas is ultimately removed from the power plant and discharged into the atmosphere by way of an exhaust stack.

The flue gas contains contaminants such as sulfur oxides (SOₓ), nitrogen oxides (NOₓ), carbon monoxide (CO) and particulates of soot or ash when coal is used as the primary fuel source. The discharge of all of these contaminants into the atmosphere is subject to federal and local regulations, which greatly restrict the levels of these flue gas components.

To meet the required levels of NOₓ emissions, many fossil fuel-fired electric generating units incorporate the use of selective catalytic reduction (SCR) technology. In this technology, ammonia or urea based reagents are typically injected in the presence of a catalytic converter to convert the NOₓ to nitrogen. The catalytic converter is typically made of a substrate and a nitrogen oxide reduction catalyst. The nitrogen oxide reduction catalyst is the catalytic material that acts to convert the NOₓ to nitrogen.

When coal is used as a combustion fuel, fly ash, a solid residue, is also generated and mixed with the flue gas. Additional pollution control equipment, such as hoppers, electrostatic precipitators or a bag-house is used to capture the fly ash prior to release.

Depending upon the source and makeup of the coal being burned, the components of the fly ash produced vary considerably. Fly ash typically includes varying amounts of silica (silicon dioxide, SiO₂) (both amorphous and crystalline), lime (calcium oxide, CaO), aluminium oxide (Al₂O₃) and iron oxide (Fe₂O₃).

In addition to fly ash, the flue gas can include components that act as inhibitors of nitrogen oxide reduction catalysts. One particular inhibitor is arsenic.

Although separate equipment is used to remove the fly ash, over time the catalytic converters nevertheless become coated with a portion of the fly ash generated during combustion. Eventually, the catalytic converters become substantially reduced in their effectiveness, i.e., become deactivated, and have to be removed from service. Often, these fly ash-coated converters can be regenerated and put back in service.

Some of the more simple methods of regenerating or removing fly ash or catalyst inhibitors from deactivated catalytic converters include treating the converters with water. Aqueous compositions that include acidic components such as sulfuric acid are also used.

U.S. Pat. No. 6,395,665 discloses a method for the regeneration of a denitration catalyst (i.e., a catalytic converter) which comprises cleaning a denitration catalyst having reduced denitration power with an aqueous alkaline solution to remove the substances deposited thereon. The catalyst is then subjected to an activation treatment with an aqueous acid solution. In a preferred embodiment, the denitration catalyst is regenerated by cleaning with a cleaning fluid comprising an aqueous solution containing sulfuric acid or ammonia at a concentration of 0.05 to 20% by weight and maintained at a temperature of 10° C. to 90° C. If necessary, the cleaned catalyst or catalytic converter can be re-impregnated with additional denitration catalyst.

U.S. Pat. No. 6,241,826 discloses a process for regenerating catalytic converters that includes placing the catalytic converter in motion in a cleaning solution and subjecting it to ultrasonic treatment. Catalytic converters so treatable include those which have ceramic bodies and which catalyze the reduction of nitrogen oxides into molecular nitrogen and which substantially include titanium oxide, TiO₂, tungsten oxide, WO₃, and vanadium pentoxide, V₂O₅.

U.S. Pat. No. 6,929,701 discloses a process for decoating a used a carrier substrate (i.e., catalytic converter) to produce a clean, inert carrier or substrate. In a preferred embodiment, the catalyst substrate is treated in an aqueous solution including an emulsifier. The substrate is also subjected to ultrasonic treatment, while treating the substrate in an aqueous solution preferably including a dispersant. The substrate is ultimately rinsed in deionized (DI) water. During treatment with the emulsifier, the solution can be agitated, for example by air injection or by mechanical means. Optional embodiments include the addition of an alkali to the emulsifier solution; rinsing between steps, for example with DI water; treatment with acid to remove sodium before final rinsing, final rinsing in a cascade system, and drying.

More effective means of regenerating or removing catalytic inhibitors, particularly fly ash or inhibitors contained in flue gas, from catalytic converters are still desired. It is particularly desirable to remove contaminants from catalytic converters without removing excessive amounts of the catalytic material in the converters. This would substantially reduce the amount of re-impregnation of the catalytic material that would be need to put the regenerated converters back into active service.

### SUMMARY OF THE INVENTION

This invention provides an effective means of regenerating or removing catalytic inhibitors from catalytic converters. The invention is capable of removing contaminants from catalytic converters without removing excessive amounts of the catalytic material in the converters. Accordingly, re-impregnation of the catalytic material is substantially reduced, if not eliminated.

According to one aspect of the invention, there is provided a method for removing a catalyst inhibitor from a substrate or a catalytic converter having a substrate and at least one NOₓ reduction catalyst. The method includes a step of contacting the substrate or catalytic converter with a phosphoric acid composition to remove at least a portion of the catalyst inhibitor from the substrate or catalytic converter. The substrate or catalytic converter is then rinsed with an aqueous composition to remove at least a portion of the phosphoric acid composition.

In one embodiment, the catalyst inhibitor comprises arsenic. In a particular embodiment, the substrate or catalytic converter that is contacted with the phosphoric acid composition is a fly ash-coated substrate or catalytic converter.

Preferably, the substrate is a metal or ceramic substrate, and the NOₓ reduction catalyst comprises at least one metal selected from the group consisting of Group 4, 5 and 6 metals.

In a particular embodiment, the phosphoric acid composition contacting the substrate or catalytic converter contains at least 1 wt % phosphoric acid, based on total weight of the composition contacting the filter. Preferably, the aqueous composition is comprised of at least 50 wt % water.

In another embodiment of the invention, the substrate or catalytic converter is contacted with the phosphoric acid composition at an average pH of not greater than 4. Preferably, the substrate or catalytic converter is contacted with the phosphoric acid composition at an average temperature of from 10° C. to 90° C.

In one embodiment, the substrate or catalytic converter is preferably agitated while being contacted with the phosphoric acid composition.

It certain embodiments, it is desirable that the rinsed substrate or catalytic converter is impregnated with at least one NOₓ removal catalyst.

### DETAILED DESCRIPTION OF THE INVENTION

This invention is directed to a method for removing a catalyst inhibitor from a substrate containing at least one nitrogen oxide (NOₓ) reducing catalyst. The method is particularly suited for removing the catalyst inhibitor, arsenic, from a fly ash-coated substrate, and in particular from a fly ash-coated catalytic converter containing a substrate and a nitrogen oxide reduction catalyst.

According to the invention, a substantial amount of catalyst inhibitor can be removed from a fly ash-coated substrate or catalytic converter using a phosphoric acid solution, without removing a significant portion of one or more of the NOₓ reduction catalysts in or on the substrate. This provides the advantage of being able to selectively remove the catalyst inhibitor, without removing a substantial portion of at least one of the NOₓ reduction catalysts from the substrate.

The substrate that is treated to remove the catalyst inhibitor is a substance capable of supporting or having embedded therein one or more metals that act as a catalyst. The substrate can also be referred to as a catalyst support material. The substrate can be of any appropriate material. Preferred substrates are metal or ceramic substrates. Particularly preferred substrates are metal or ceramic substrates having plate, honeycomb, corrugated or mesh-type configuration.

Metallic substrates that can be used in accordance with this invention include may be composed of one or more metals or metal alloys. In one embodiment, the metallic substrates are employed as a mesh-type support substrate. Preferred metallic materials include heat resistant metals and metal alloys such as titanium and stainless steel as well as other alloys in which iron is a substantial or major component. Such alloys may contain one or more metals selected from the group consisting of nickel, chromium and aluminum.

In a preferred embodiment, the substrate is a metallic substrate that is comprised of a metal alloy material. Preferably, the alloy material is comprised of from 3 wt % to 30 wt % chromium. In another embodiment, the alloy material is comprised of from 1 wt % to 10 wt % aluminum. In yet another embodiment, the alloy material is comprised of from 5 wt % to 50 wt % nickel, based on total weight of the metal substrate, excluding catalyst.

The alloys may also contain small or trace amounts of one or more other metals such as manganese, copper, vanadium, titanium and the like. The surface of the metal carriers may be oxidized at high temperatures, e.g., 1000° C. and higher, to improve the corrosion resistance of the alloy, such as by forming an oxide layer on the surface of the carrier. Such high temperature-induced oxidation may enhance the adherence of a refractory metal oxide support and catalyst components to the carrier.

One particular metal substrate that can be used as a substrate in a catalytic converter is an iron-chromium alloy. In one embodiment, the iron-chromium alloy is in the form of a foil, and preferably has a thickness of from about 0.02 mm to about 0.06 mm.

Ceramic substrates that can be used in accordance with this invention include any suitable refractory material. Examples of suitable refractory material include, but are not limited to, cordierite, cordierite-alpha alumina, silicon nitride, zircon mullite, spodumene, alumina-silica magnesia, zircon silicate, sillimanite, magnesium silicates, zircon, petalite, alpha alumina, aluminosilicates and the like.

In one embodiment of the invention, catalytic converters that are treated according to this invention have a substrate that is of a honeycomb structure or configuration. Any suitable substrate may be employed. In one embodiment, the substrate is a monolithic substrate of the type having a plurality of parallel gas flow passages. The passages are preferably substantially straight paths that extend from their fluid inlet to their fluid outlet. The substrate material has embedded therein or deposited thereon the catalytic material, e.g., at least one NOₓ reduction catalyst. The flow passages are preferably thin-walled. Suitable cross-sectional shape and size of the flow passages include trapezoidal, rectangular, square, sinusoidal, hexagonal, oval, circular, etc., structure. Such structures preferably contain from about 12 to about 600 gas inlet openings (i.e., “cells”) per square inch of cross section.

This invention is particularly suited to treating fly ash-coated catalytic converters or fly ash-coated substrates. Fly ash is particularly difficult to remove from catalytic converters or substrates that are used to reduce NOx emissions from combustion processes that use coal as the energy source.

Fly ash can ultimately coat the catalytic converter or substrate such that there is limited ability of the NOₓ components produced in the combustion process to contact the NOₓ reduction catalyst in the converter or substrate. This causes the NOₓ reduction to become essentially if not completely ineffective.

The invention is particularly suited to treating fly ash-coated converters or substrates that contain catalyst inhibitors. The invention is particularly effective in treating or removing Group 15 metal inhibitors, particularly the Group 15 metals arsenic and antimony. The invention is particularly suited to treating or removing arsenic.

The NOₓ reduction catalyst that can be incorporated into or onto the substrate that is treated according to this invention is a composition that converts NOₓ to nitrogen and water using a gas phase reducing agent such as ammonia or hydrogen. In a preferred embodiment, the catalytic converter or substrate that is treated according to the invention comprises at least one NOₓ reduction catalyst selected from the group consisting of Group 4, 5 and 6 metals. More preferably, the catalytic converter or substrate that is treated according to the invention comprises at least one NOₓ reduction catalyst selected from the group consisting of vanadium, tungsten and molybdenum. These metals are present in any form that provides catalytic activity including their oxide forms and including combinations of their various active forms. Such examples include but are not limited to TiO₂—WO₃ or TiO₂—MoO₃ binary catalysts, and TiO₂—V₂O₅—WO₃ or TiO₂—V₂O₅—MoO₃ ternary catalysts.

In one embodiment, the NOₓ reduction catalyst includes vanadium. In a particular embodiment of the invention, catalyst inhibitor is removed from a catalytic converter comprised of a substrate and vanadium. The catalytic converter preferably includes at least 0.1 wt. % vanadium, based on total weight of the catalytic converter. More preferably, the catalytic converter contains from 0.1 wt. % to 4 wt. % vanadium, and most preferably from 0.2 wt % to 2 wt. % vanadium, based on total weight of the catalytic converter.

In another embodiment, the NOₓ reduction catalyst includes tungsten. In another embodiment, of the invention, catalyst inhibitor is removed from a catalytic converter comprised of a substrate and tungsten. The catalytic converter preferably includes at least 1 wt. % tungsten, based on total weight of the catalytic converter. More preferably, the catalytic converter contains from 1 wt. % to 14 wt. % tungsten, and most preferably from 2 wt % to 12 wt. % tungsten, based on total weight of the catalytic converter.

In another embodiment, the NOₓ reduction catalyst includes molybdenum. In another embodiment, of the invention, catalyst inhibitor is removed from a catalytic converter comprised of a substrate and molybdenum. The catalytic converter preferably includes at least 5 wt. % molybdenum, based on total weight of the catalytic converter. More preferably, the catalytic converter contains from 5 wt. % to 18 wt. % molybdenum, and most preferably from 7 wt % to 16 wt. % molybdenum, based on total weight of the catalytic converter.

The method of this invention involves treating or contacting the substrate or catalytic converter with a phosphoric acid composition to remove at least a portion of fly ash or a catalyst inhibitor from the substrate or catalytic converter. The phosphoric acid composition is preferably an aqueous composition that is effective in not only removing the fly ash and various inhibitors of NOₓ reduction catalyst, but it has little impact on removing various NOₓ reduction catalyst components from the substrate or catalytic converter. For example, treatment with the phosphoric acid composition does not remove a significant amount of the NOₓ reduction catalyst, tungsten.

The phosphoric acid composition that is used to treat or contact the substrate or converter preferably contains at least 0.5 wt % phosphoric acid, based on total weight of the composition contacting the substrate or converter. More preferably, the phosphoric acid composition that is used to treat or contact the substrate or converter contains from 0.5 wt % to 15 wt % phosphoric acid, and more preferably from 1 wt % to 10 wt % phosphoric acid, based on total weight of the composition contacting the substrate or filter.

In a preferred embodiment, the phosphoric acid composition further comprises at least one surfactant. A surfactant (i.e., surface-active agent) is considered to be any compound that reduces surface tension when dissolved in water or water solutions, or that reduces interfacial tension between two liquids, or between a liquid and a solid. Preferably, the phosphoric acid composition further includes 0.01 wt % surfactant, more preferably at least 0.05 wt % surfactant, based on total weight of the phosphoric acid composition. It is also preferred that the phosphoric acid composition contain not greater than 0.5 wt %, more preferably not greater than 0.2 wt % surfactant, based on total weight of the phosphoric acid composition.

The phosphoric acid composition is treated or contacted with the substrate or converter for a time that removes a substantial amount, i.e., a majority, of the fly ash or NOₓ reduction catalyst inhibitor. Preferably the phosphoric acid composition is treated or contacted with the substrate or converter for at least 10 minutes. More preferably, phosphoric acid composition is treated or contacted with the substrate or converter for at least 1 hour and most preferably for at least 2 hours. Treatment can be extended for as long as desired, but it is preferably that treatment be not greater than 48 hours, more preferably not greater than 24 hours.

The phosphoric acid composition is preferably treated or contacted with the substrate or converter in a vessel that is suitable for immersing the substrate or converter into the phosphoric acid solution. Agitation during treatment is preferred. Either the solution can be agitated or the substrate or converter can be moved to cause agitation. The solution can be agitated by any suitable means, including by mechanical means or by flowing a fluid such as air through the phosphoric acid composition.

Treatment of the substrate or converter is preferably carried out at an average pH during treatment of not greater than 4. Preferably, treatment of the substrate or converter is preferably carried out at an average pH during treatment of not greater than 4, and more preferably not greater than 3.

Average temperature during treatment of the substrate or converter is preferably at least 10° C. More preferably, the average temperature during treatment of the substrate or converter is preferably from 10° C. to 90° C., more preferably from 20° C. to 80° C., and most preferably from 30° C. to 60° C.

Following treatment with the phosphoric acid composition, the substrate or converter is preferably rinsed with an aqueous composition to remove at least a portion of the phosphoric acid composition. Rinsing can be accomplished by any practical means. Examples of rinsing include, but are not limited to, spraying, immersion, or a combination of methods.

The aqueous composition used for rinsing is preferably comprised of at least 50 wt % water. More preferably, the aqueous rinsing composition is distilled water, de-ionized water, or tap water.

In one embodiment of the invention, fly ash and large particles of contaminants are physically removed from the substrate or converter prior to treating with the phosphoric acid composition. This physical removal of fly ash and contaminants can be accomplished, for example, by moving a stream of pressurized vapor, e.g., air, across or through the substrate or converter to loosen or dislodge material that has collected on the substrate or converter. In one particular example, an air gun (e.g., 50-100 psi) is used as a source of pressurized air. A vacuum device can be used to collect loose or dislodged particles. Total time for dislodging particles from the substrate or converter depends on the size of the substrate or converter, but is typically from 5 to 60 minutes.

In another embodiment of the invention, the substrate or converter is treated or contacted with a second phosphoric acid composition prior to washing or rinsing with the aqueous composition. This second composition is an aqueous composition that has a concentration of phosphoric acid that is less than the first composition. Preferably, the second composition has a concentration of phosphoric acid that is at least 10% less, more preferably at least 25% less, and most preferably at least 50% less than the first composition. The second composition should also contain at least 0.1 wt %, preferably at least 0.5 wt %, phosphoric acid, based on total weight of the second composition.

The pH of the second phosphoric acid composition can be maintained at a higher average pH than that of the first phosphoric acid composition. Preferably, the pH of the second phosphoric acid composition is maintained at an average of at least 0.5 pH units higher than that of the first phosphoric acid composition during treatment. More preferably, the pH of the second phosphoric acid composition is maintained at an average of at least 1 pH units higher, most preferably an average of at least 2 pH units higher, than that of the first phosphoric acid composition.

Removal of the fly ash or NOₓ reduction catalyst inhibitor can be enhanced by ultrasonic treatment. Ultrasonic treatment takes place by exposing the aqueous composition used to treat the substrate or converter to ultrasonic sound. The composition to which ultrasonic sound is applied can be any of the aqueous compositions described herein. Preferably, ultrasonic treatment or exposure to ultrasonic sound is applied to the second phosphoric acid composition or the rinse composition or both.

In one embodiment, the substrate or catalytic converter is exposed to a high- frequency ultrasonic vibration, with a simultaneous flow of aqueous composition across the substrate or converter. The intensity of the ultrasound can be regulated and adapted to the degree of soiling. Preferably, ultrasonic sound is applied in the range of from about 15 kHz per 5 watts per liter of aqueous composition to about 40 kHz per 5 watts per liter of aqueous composition, more preferably from about 18 kHz per 5 watts per liter of aqueous composition to about 30 kHz per 5 watts per liter of aqueous composition.

After rinsing, the substrate or converter is dried. Drying can be accomplished by an suitable means. Preferably the substrate or converter is dried in air. More preferably, the rinsed substrate or converter is dried by passing air across the substrate or converter. The air that is used for drying is preferably at a temperature of from 20° C. to 400° C., more preferably from 100° C. to 300° C.

Once the substrate or converter is dried, the substrate or converter can be impregnated with at least one NOₓ removal catalyst. This impregnation can be used to return the substrate or converter to its former NOₓ removal activity or to enhance NOₓ removal activity from any baseline condition. The substrate or converter can be impregnated with one or more NOₓ reduction catalyst metals selected from the group consisting of Group 4, 5 and 6 metals. In one embodiment, the substrate or catalytic converter is impregnated with vanadium or tungsten so that the active component is supported on or embedded in the substrate or converter.

As one example of impregnating the substrate or catalytic converter with vanadium, it may be soaked in an aqueous solution prepared by dissolving a vanadium compound (e.g., vanadium oxalate, ammonium metavanadate or vanadyl sulfate) in water, an organic acid, or an amine solution. As one example, a phosphoric acid treated catalyst is placed in a solution of vanadium oxylate which contains from 0.1 wt. % to 4 wt. % vanadium in the form of vanadium pentoxide for a period of from 1 minute to 60 minutes, preferably from 2 minutes to 20 minutes. Following vanadium impregnation, the substrate or catalytic converter is heat treated in a drying oven to a final temperature of at least 150° C., preferably at least 200° C. The actual amount of vanadium taken up by the substrate or catalytic converter in the impregnation process is measured by x-ray fluorescence spectroscopy. In one embodiment, the impregnated substrate or catalytic converter contains about 1% by weight to about 3% by weight of V₂O₅, based on total weight of the impregnated substrate or catalytic converter.

As one example of impregnating the substrate or catalytic converter with tungsten, it may be soaked in an aqueous solution prepared by dissolving a tungsten compound (e.g., ammonium-tungstate or tungsten chloride) in water, hydrochloric acid, an amine solution or an organic acid. In one embodiment, tungsten is impregnated in combination with vanadium. This can be accomplished in a single step or in separate steps.

As one example of tungsten and vanadium impregantion, chemically compatible forms of tungsten and vanadium, such as ammonium vanadate and ammonium para-tungstate, are combined in a single solution containing from 0.5% to 3% vanadium in the ammonium vanadate solution (measured as V₂O₅), and from 3% to 8% tungsten in the ammonium para-tungstate solution (measured as WO₃). A phosphoric acid treated catalyst is exposed to this base metal containing solution for a period of from 1 minute to 60 minutes, preferably from 2 minutes to 20 minutes, and then heat treated in a drying oven to a final temperature of at least 150° C., preferably at least 200° C.

In one embodiment, tungsten is impregnated as ammonium para-tungstate, and the substrate or catalytic converter is preferably heat treated in a calcining furnace to convert ammonium para-tungstate to its catalyticlly useful oxide form, WO₃, preferably at least 500° C., more preferably 600° C. Following heat treatment and calcinations, the concentrations of vanadium and tungsten are measured by x-ray fluorscense spectroscopy. Desirable concentrations of these metals would be from 0.5% vanadium pentoxide and 2% to 9% tungsten trioxide, based on total weight of the impregnated substrate or catalytic converter.

### EXAMPLE

The invention will be further clarified by the following Example.

A deactivated honeycomb catalyst was obtained. The catalyst was coated with fly ash from sub-bituminous coal. The catalyst was 100% plugged.

To demonstrate the ability of phosphoric acid treatment to selectively and preferentially remove arsenic from deactivated substrate materials, a series of four coupon size samples were cut from a single deactivated honeycomb-type converter. Each sample was approximately 3″ width by 3″ depth by 4″ length and weighed about 600 grams before treatment. Samples were treated in beakers that contained the treatment solutions 1 through 4 as shown in the Table below. Treatment solutions were held at between 20° C. and 22° C. for a total time of 60 minutes each. Samples of the treatment solution were then analyzed for their relative concentrations of arsenic, vanadium and tungsten using a Horiba JY ICP. Because all untreated samples were taken from the same deactivated honeycomb element, all samples had approximately the same initial concentrations of arsenic, vanadium and tungsten. Therefore, the amount of each of those species detected in the treatment solution was assumed to be in direct proportion to the amount removed from the deactivated catalyst. Accordingly, the more of a particular species in solution the more that was removed from the catalyst.

TABLE

| | Treatment 1 | Treatment 2 | Treatment 3 | Treatment 4 |
|---|---|---|---|---|
| Treatment chemical | H₂SO₄ | HCl | H₃PO₄ | NaOH |
| MW of chemical | 98.078 | 36.46 | 98 | 39.9971 |
| Percent active component in | 50% | 37% | 85% | 50% |
| stock solution | | | | |
| Wt stock soln (gm) | 20 | 22 | 86 | 40 |
| Total treatment solution volume | 1000 | 1000 | 1000 | 1000 |
| (ml) | | | | |
| Treatment chemical | 1.00% | 0.81% | 7.31% | 2.00% |
| concentration (w/w) | | | | |
| Treatment chemical | 0.10 | 0.22 | 0.75 | 0.50 |
| concentration (molar) | | | | |
| pH (measured) | 1.1 | 0.96 | 1.15 | >12 |
| Surfactant added (wt %) | 0.2% | 0.2% | 0.2% | 0.2% |
| Initial sample weight | 554.48 | 657.1 | 733.8 | 558.6 |
| Plugged cells before treatment | 75 | 83 | 94 | 84 |
| (all 100% plugged) | | | | |
| Initial treatment soln amount | 916.344 | 827.13 | 720.14 | 647.58 |
| (estimate) | | | | |
| Liquid left after treatment (gm) | 750 | 630 | 500 | 480 |
| Treated catalyst color | un-changed | un-changed | light purple | un-changed |
| Final treatment soln color | green/blue | green/blue | blue | colorless |
| Final dried catalyst weight | 344.09 | 452.22 | 527.56 | 459.75 |
| Percent material removed | 38% | 31% | 28% | 18% |
| Plugged cells after treatment | 30 | 49 | 60 | 61 |
| Percent cells opened by | 60% | 41% | 36% | 27% |
| treatment | | | | |
| Arsenic recovered in treatment | 38 | 54 | 500 | 476 |
| solution (ppm) | | | | |
| Vanadium recovered in treatment | 600 | 605 | 535 | 391 |
| solution (ppm) | | | | |
| Tungsten recovered in treatment | 7 | 6 | 27 | 1763 |
| solution (ppm) | | | | |

The above Table indicates that the phosphoric acid composition of this invention is capable of removing a substantial amount of the NOₓ reduction catalyst inhibitor, arsenic, from the fly ash-coated substrate. Although the phosphoric acid treatment was shown to remove an amount of arsenic that is comparable to sodium hydroxide treatment, phosphoric acid treatment removes significantly less tungsten. No other treatment shows significant arsenic removal with minimal tungsten removal.

The foregoing disclosure provides illustrative embodiments of the invention and is not intended to be limiting. As understood by those of skill in the art, the overall invention, as defined by the claims, encompasses other preferred embodiments not specifically enumerated herein.

1. A method for removing arsenic from a catalytic converter comprised of a substrate and at least one NOₓ reduction catalyst that includes tungsten, comprising:
contacting the catalytic converter with a phosphoric acid composition to remove at least a portion of the arsenic from the catalytic converter, while removing less tungsten from the catalytic converter than arsenic; and
rinsing the catalytic converter with an aqueous composition to remove at least a portion of the phosphoric acid composition.

2. (canceled)

3. The method of claim 1, wherein the catalytic converter that is contacted with the phosphoric acid composition is a fly ash-coated catalytic converter.

4. The method of claim 1, wherein the substrate is a metal or ceramic substrate.

5. The method of claim 1, wherein the NOₓ reduction catalyst comprises at least one additional metal selected from the group consisting of Group 4, 5 and 6 metals.

6. The method of claim 1, wherein the phosphoric acid composition contacting the catalytic converter contains at least 1 wt % phosphoric acid, based on total weight of the composition contacting the catalytic converter.

7. The method of claim 1, wherein the phosphoric acid composition comprises at least one surfactant.

8. The method of claim 1, wherein the aqueous composition is comprised of at least 50 wt % water.

9. The method of claim 1, The method of claim 1, wherein the catalytic converter is contacted with the phosphoric acid composition at an average pH of not greater than 4.

10. The method of claim 1, wherein the catalytic converter is contacted with the phosphoric acid composition at an average temperature of from 10° C. to 90° C.

11. The method of claim 1, wherein the catalytic converter is agitated while being contacted with the phosphoric acid composition.

12. The method of claim 1, wherein the rinsed catalytic converter is impregnated with at least one NOₓ removal catalyst.

13. A method for removing arsenic from a metal or ceramic substrate that comprises at least one NOₓ reduction catalyst that includes tungsten, comprising:
contacting the substrate with a phosphoric acid composition to remove at least a portion of the arsenic from the substrate, while removing less tungsten from the catalytic converter than arsenic; and
rinsing the substrate with an aqueous composition to remove at least a portion of the phosphoric acid composition.

14. (canceled)

15. The method of claim 14, wherein the at least one NOₓ reduction catalyst is comprised of at least one additional metal selected from the group consisting of Group 4, 5 and 6 metals.

16. (canceled)

17. The method of claim 13, wherein the substrate that is contacted with the phosphoric acid composition is fly ash-coated.

18. The method of claim 13, wherein the phosphoric acid composition contacting the substrate contains at least 1 wt % phosphoric acid, based on total weight of the composition contacting the catalytic converter.

19. The method of claim 13, wherein the phosphoric acid composition comprises at least one surfactant.

20. The method of claim 13, wherein the substrate is contacted with the phosphoric acid composition at an average pH of not greater than 4.
